(19) United States
(12) Patent Application Publication
(10) Pub. No.: US 2026/0168967 A1
(43) Pub. Date: Jun. 18, 2026

(54) ACOUSTIC WAVE INSPECTION DEVICE

(71) Applicant: KABUSHIKI KAISHA TOSHIBA, Tokyo (JP)

(72) Inventors: Akiko HIRAO, Kawasaki (JP); Noriko YAMAMOTO, Yokohama (JP); Takashi KUMATA, Kawasaki (JP)

(73) Assignee: KABUSHIKI KAISHA TOSHIBA, Tokyo (JP)

(21) Appl. No.: 19/256,413

(22) Filed: Jul. 1, 2025

(30) Foreign Application Priority Data
Dec. 18, 2024 (JP) 2024-221385

(51) Int. Cl. G01N 29/24; G01N 29/04

(52) U.S. Cl. CPC G01N 29/24; G01N 29/04; G01N 2291/023; G01N 2291/101

(57) ABSTRACT

According to one embodiment, an acoustic wave inspection device includes a transducer, a first member, a second member, a sheet member, and an elastic member. The first member is around the transducer in a first plane. The second member is between the transducer and the first member in the first plane. The sheet member includes a plurality of openings. The sheet member includes a first partial region and a second partial region. The second partial region is between the first member and the second member in the first plane. The second partial region is fixed to at least one of the first member or the second member. The elastic member is arranged between the first partial region and the transducer in a first direction crossing the first plane.

### CROSS-REFERENCE TO RELATED APPLICATIONS

This application is based upon and claims the benefit of priority from Japanese Patent Application No.2024-221385, filed on Dec. 18, 2024; the entire contents of which are incorporated herein by reference.

### FIELD

Embodiments described herein relate generally to an acoustic wave inspection device.

### BACKGROUND

In acoustic wave inspection devices that use acoustic waves such as ultrasonic waves, it is desirable to improve the characteristics.

### BRIEF DESCRIPTION OF THE DRAWINGS

FIGS. 1A to 1C are schematic views illustrating an acoustic wave inspection device according to a first embodiment; and

FIGS. 2A to 2C are schematic diagrams illustrating an acoustic wave inspection device according to a second embodiment.

### DETAILED DESCRIPTION

According to one embodiment, an acoustic wave inspection device includes a transducer, a first member, a second member, a sheet member, and an elastic member. The first member is around the transducer in a first plane. The second member is between the transducer and the first member in the first plane. The sheet member includes a plurality of openings. The sheet member includes a first partial region and a second partial region. The second partial region is between the first member and the second member in the first plane. The second partial region is fixed to at least one of the first member or the second member. The elastic member is arranged between the first partial region and the transducer in a first direction crossing the first plane.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

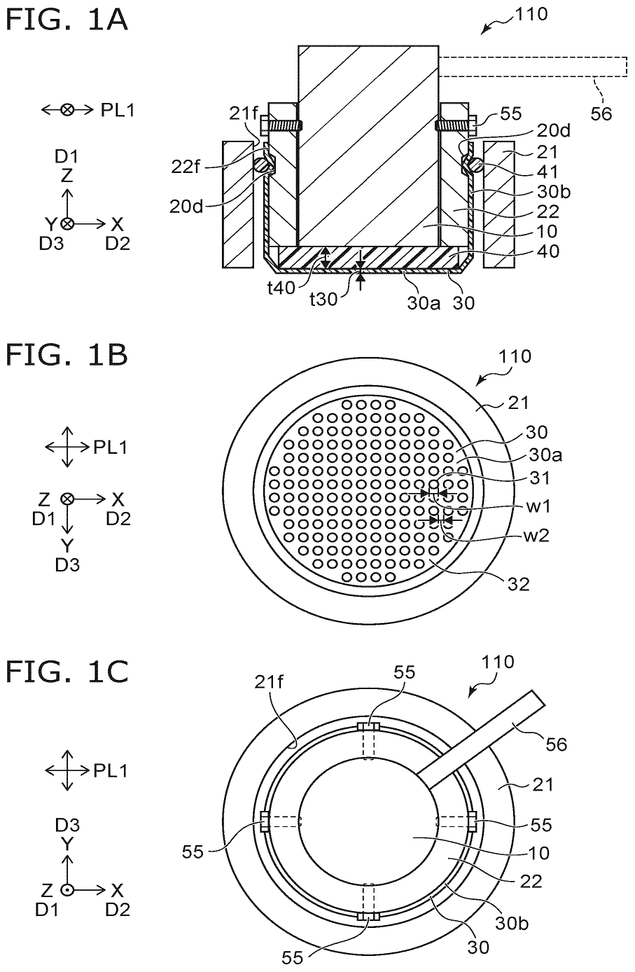

FIGS. 1A to 1C are schematic views illustrating an acoustic wave inspection device according to a first embodiment.

FIG. 1A is a cross-sectional view. FIG. 1B is a bottom view. FIG. 1C is a top view.

As shown in FIGS. 1A to 1C, an acoustic wave inspection device 110 according to the embodiment includes a transducer 10, a first member 21, a second member 22, a sheet member 30, and an elastic member 40.

The first member 21 is provided around the transducer 10 in a first plane PL1. The second member 22 is provided between the transducer 10 and the first member 21 in the first plane PL1. The first member 21 is, for example, an outer member. The second member 22 is, for example, an inner member.

As shown in FIG. 1B, the sheet member 30 includes a plurality of openings 31. In FIG. 1A, the plurality of openings 31 are omitted. As shown in FIG. 1A, the sheet member 30 includes a first partial region 30a and a second partial region 30b. The second partial region 30b is located between the first member 21 and the second member 22 in the first plane PL1. The second partial region 30b is fixed to at least one of the first member 21 or the second member 22. The sheet member 30 is, for example, a mesh member. The sheet member 30 includes non-opening portions 32 between the plurality of openings 31.

The elastic member 40 is provided between the first partial region 30a and the transducer 10 in a first direction crossing the first plane PL1. The elastic member 40 is, for example, an elastomer. The elastic member 40 may include, for example, a polymer.

The first direction D1 is defined as a Z-axis direction. One direction perpendicular to the Z-axis direction is defined as an X-axis direction. A direction perpendicular to the Z-axis direction and the X-axis direction is defined as a Y-axis direction. The first plane PL1 is, for example, along the X-Y plane. The first partial region 30a may be along the second direction D2 and the third direction D3. The second direction D2 crosses the first direction D1. The third direction D3 crosses a plane including the first direction D1 and the second direction D2. The second direction D2 may be, for example, the X-axis direction. The third direction D3 may be, for example, the Y-axis direction.

For example, acoustic waves are emitted from the transducer 10. The acoustic waves are reflected by a target object and enter the transducer 10. By detecting a state of the acoustic waves that enter the transducer 10, the state of the target object (e.g., scratches, etc.) can be detected. Thus, the transducer 10 is configured to perform at least one of emitting acoustic waves or detecting acoustic waves. The transducer 10 may include, for example, a piezoelectric element.

A frequency of the acoustic waves may be, for example, not less than 0.5 MHz and not more than 15 MHz. The acoustic waves may be, for example, ultrasonic waves. The acoustic wave inspection device 110 may be, for example, an ultrasonic wave inspection device. Pulsed acoustic waves may be used.

In the embodiment, the first partial region 30a of the sheet member 30 (e.g., a mesh member) is pressed against the target object. A generated stress causes a part of the elastic member 40 to come into contact with the target object through the plurality of openings 31. Air or the like existing between the target object and the elastic member 40 is eliminated. Sound wave is transmitted to the target object. By moving the transducer 10 in a direction along the first direction D1, it is possible to inspect the condition of the target object. For example, inspection is possible without the use of a liquid couplant or the like. In FIG. 1A, the shape of the openings is circular. In the embodiment, the shape of the openings may be rectangular, square, diamond, hexagonal, or the like.

In one example, acoustic waves (e.g., ultrasound wave) emitted from transducer 10 are incident on the target object via the elastic member 40. Acoustic waves reflected from the target object are incident on the transducer 10 via the elastic member 40. The transducer 10 is configured to output a signal based on the received acoustic waves. The signal corresponds to the state of the target object. In another example, the transducer 10 may detect acoustic waves emitted from the target object.

The first partial region 30a is pressed against the target object, and a force along the first direction D1 is applied to the first partial region 30a. In this embodiment, the second partial region 30b is provided between the first member 21 and the second member 22 in a direction crossing the first direction D1 (direction along the first plane PL1). The second partial region 30b is fixed to at least one of the first member 21 or the second member 22. The fixing direction is a direction crossing the first direction D1 (direction along the first plane PL1). As a result, the sheet member 30 is stably fixed to at least one of the first member 21 or the second member 22.

For example, when a force is applied to the first partial region 30a along the first direction D1, the position of the sheet member 30 is prevented from shifting. For example, the state in which the first partial region 30a is pressed against the target object is stabilized. This allows the state of the target object stably and with high accuracy. For example, the state of the target object can be detected stably and with high responsiveness. According to the embodiment, it is possible to provide an acoustic wave inspection device whose characteristics can be improved.

In the embodiment, the tension of the first partial region 30a may be, for example, 1 N/cm or more. For example, the contact state between the elastic member 40 and the target object is likely to be stable.

In the embodiment, a Young's modulus of the sheet member 30 may be higher than a Young's modulus of the elastic member 40. For example, the contact state between the elastic member 40 and the target object is more likely to be stable.

The Young's modulus of the elastic member 40 may be, for example, not less than 0.1 MPa and not more than 100 MPa. An elastic member thickness t40 (see FIG. 1A) of the elastic member 40 along the first direction D1 may be, for example, not less than 0.5 mm and not more than 2 mm.

A thickness t30 of the first partial region 30a along the first direction D1 may be, for example, not less than 50 μm and not more than 500 μm. The elastic member 40 can be in stable contact with the target object through the plurality of openings 31.

A width w1 (see FIG. 1B) of the plurality of openings 31 along the first plane PL1 may be, for example, not less than 10 μm and not more than 1200 μm. The elastic member 40 can be in stable contact with the target object through the plurality of openings 31.

The sheet member 30 includes one of the plurality of openings 31 and another one of the plurality of openings 31. The other one of the plurality of openings 31 is next to the one of the plurality of openings 31. A distance w2 between the other one of the plurality of openings 31 and the one of the plurality of openings 31 may be, for example, not less than 10 μm and not more than 500 μm. The elastic member 40 can be in stable contact with the target object through the plurality of openings 31. The distance w2 may be the minimum value of the distance between the other one of the plurality of openings 31 and the one of the plurality of openings 31.

In the embodiment, the Young's modulus of the sheet member 30 may be, for example, not less than 100 MPa and not more than 700 GPa. The tension of the first partial region 30 a makes it easier to stabilize the contact state between the elastic member 40 and the target object through the plurality of openings 31.

In the embodiment, the sheet member 30 is configured to contact the target object. The distance between the target object and the transducer 10 along the first direction D1 may be configured to change reversibly. The tension of the first partial region 30a and the elastic member 40 being appropriate tend to stabilize the contact state between the elastic member 40 and the target object via the plurality of openings 31.

As shown in FIGS. 1A and 1C, the first member 21 includes a first facing portion 21f facing the second member 22. The first facing portion 21f is, for example, an inner side face. As shown in FIGS. 1A and 1C, the first facing portion 21f may be tubular. For example, the first facing portion 21f may be cylindrical or polygonal tubular.

The second member 22 includes a second facing portion 22f facing the first member 21. A direction from the first facing portion 21f to the second facing portion 22f is along the first plane PL1. The second facing portion 22f is an outer side face. The second facing portion 22f is along the first facing portion 21f.

The second partial region 30b is located between the first facing portion 21f and the second facing portion 22f. The second partial region 30b may be fixed by the first facing portion 21f and the second facing portion 22f.

As shown in FIG. 1A, at least one of the first facing portion 21f or the second facing portion 22f may include a recess 20d. In this example, the second facing portion 22f includes the recess 20d. At least a part of the second partial region 30b is in the recess 20d. The second partial region 30b is stably fixed. At least one of the first facing portion 21f or the second facing portion 22f may include the recess 20d and a protrusion. For example, the protrusion of the second facing portion 22f may be provided in the recess 20d of the first facing portion 21f. For example, the protrusion of the first facing portion 21f may be provided in the recess 20d of the second facing portion 22f.

In the example of FIG. 1A, the second partial region 30b may be fixed by another member (for example, a first fixing member 41). The first fixing member 41 may be, for example, an elastic part. The first fixing member 41 may be, for example, a gasket or the like. The first fixing member 41 is located between the first facing portion 21f and the second facing portion 22f. In this example, the second partial region 30b is located between the recess 20d of the second facing portion 22f and the first fixing member 41. The second partial region 30b is stably fixed.

Thus, the acoustic wave inspection device 110 may further include the first fixing member 41. The first fixing member 41 may be located at at least one of a first position between the first member 21 and the second partial region 30b, or a second position between the second member 22 and the second partial region 30b.

In the embodiment, a first Young's modulus of the first fixing member 41 may be lower than a second Young's modulus of the second partial region 30b. The first fixing member 41 may be easily deformed. The second partial region 30b is stably fixed.

In the embodiment, the first fixing member 41 may fix the second partial region 30b to at least one of the first member 21 or the second member 22. For example, the first fixing member 41 may fix the second partial region 30b to at least one of the first facing portion 21f or the second facing portion 22f. In this case, the first fixing member 41 may include a screw or the like. The first fixing member 41 may include, for example, an adhesive or the like.

As shown in FIG. 1A, the transducer 10 may be fixed to the second member 22 by a fixing portion 55. The fixing portion 55 may be, for example, a screw. The fixing portion 55 may include, for example, a plunger.

In the embodiment, the sheet member 30 may include at least one selected from the group consisting of, for example, polyolefin and fluororesin. The sheet member 30 may include at least one selected from the group consisting of, for example, polyester, polyethylene, polypropylene, polytetrafluoroethylene, polychlorotrifluoroethylene, polyvinylidene fluoride, polyvinyl fluoride, polyphenylene sulfide, and polyvinylidene chloride.

In the embodiment, the elastic member 40 may include at least one selected from the group consisting of, for example, thermoplastic resins and thermosetting resins. The elastic member 40 may include at least one selected from the group consisting of, for example, polystyrene-based thermoplastic elastomers, polyolefin-based thermoplastic elastomers, vinyl chloride-based thermoplastic elastomers, polyurethane-based thermoplastic elastomers, polyester-based thermoplastic elastomers, polyamide-based thermoplastic elastomers, styrene-butadiene rubber, isoprene rubber, butadiene rubber, chloroprene rubber, acrylonitrile-butadiene rubber, isobutylene-isoprene rubber, ethylene-propylene rubber, ethylene-propylene-diene rubber, urethane rubber, silicone rubber, fluororubber, chlorosulfonated polyethylene, chlorinated polyethylene, acrylic rubber, polysulfide rubber, and epichlorohydrin rubber.

In the embodiment, the transducer 10 may be connected to a controller via a connector 56.

In the embodiment, the transducer 10 may be a vertical probe, an angle beam probe, or a dual element vertical probe.

### Second Embodiment

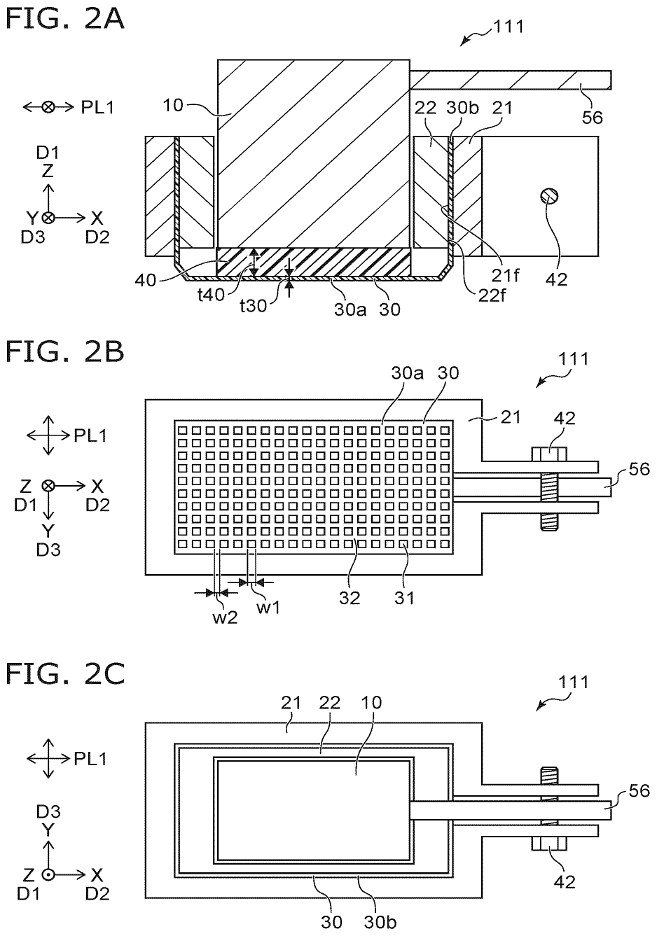

FIGS. 2A to 2C are schematic diagrams illustrating an acoustic wave inspection device according to a second embodiment.

FIG. 2A is a cross-sectional view. FIG. 2B is a bottom view. FIG. 2C is a top view.

As shown in FIGS. 2A to 2C, a second fixing member 42 is provided in an acoustic wave inspection device 111 according to an embodiment. The configuration of the acoustic wave inspection device 111 except for this may be the same as the configuration of the acoustic wave inspection device 110.

In addition to the transducer 10, the first member 21, the second member 22, the sheet member 30, and the elastic member 40, the acoustic wave inspection device 111 further includes the second fixing member 42. The second fixing member 42 is configured to fix the distance between the first member 21 and the second member 22. The second fixing member 42 may be, for example, a screw.

For example, at least a part of the second partial region 30b is provided between the first facing portion 21f and the second facing portion 22f. The second fixing member 42 fixes the distance between the first facing portion 21f and the second facing portion 22f, thereby stably fixing the second partial region 30b.

The acoustic wave inspection device 111 can also detect the state of the target object stably and with high accuracy. It is possible to provide an acoustic wave inspection device that can improve characteristics.

Examples of the characteristics of the samples are described below.

A first sample has the structure shown in FIGS. 1A to 1C. The transducer 10 is tubular. The diameter of the transducer 10 is 20 mm. The frequency of the transducer is 2.25 MHz. The material of the elastic member 40 is styrene-butadiene elastomer. The hardness of the elastic member 40 based on JIS type E is 4. The thickness of the elastic member 40 is 1 mm. The material of the sheet member 30 is polyester mesh. The thread diameter of the polyester mesh is 50 μm. The width of the openings is approximately 300 μm. The opening rate is 74%.

In the first sample, it took approximately 10 ms for the amplitude of the echo waveform to reach 80% of the saturation value.

In a second sample, the elastic member 40 is fixed between the sheet member 30 and the transducer 10 in the first direction D1. In the second sample, the time required for the amplitude of the echo waveform to reach 80% of the saturation value is approximately 100 ms. The saturation value in the second sample is approximately 60% of the saturation value in the first sample. Thus, in the first sample, high-speed response is obtained. In the first sample, a high-intensity signal is obtained.

The embodiment may include the following Technical proposals:

### Technical Proposal 1

An acoustic wave inspection device comprising:
a transducer;
a first member being around the transducer in a first plane;
a second member being between the transducer and the first member in the first plane;
a sheet member including a plurality of openings, the sheet member including a first partial region and a second partial region, the second partial region being between the first member and the second member in the first plane, the second partial region being fixed to at least one of the first member or the second member; and
an elastic member arranged between the first partial region and the transducer in a first direction crossing the first plane.

### Technical Proposal 2

The acoustic wave inspection device according to Technical proposal 1, wherein
the transducer is configured to perform at least one of emitting acoustic waves or detecting acoustic waves.

### Technical Proposal 3

The acoustic wave inspection device according to Technical proposal 1 or 2, wherein
the first member includes a first facing portion,
the second member includes a second facing portion,
a direction from the first facing portion to the second facing portion is along the first plane,
the second partial region is between the first facing portion and the second facing portion, and
at least one of the first facing portion or the second facing portion includes a recess.

### Technical Proposal 4

The acoustic wave inspection device according to Technical proposal 1 or 2, further comprising:
a first fixing member,
the first fixing member being located at a position of at least of a first position between the first member and the second partial region, and a second position between the second member and the second partial region.

### Technical Proposal 5

The acoustic wave inspection device according to Technical proposal 4, wherein
a first Young's modulus of the first fixing member is lower than a second Young's modulus of the second partial region.

### Technical Proposal 6

The acoustic wave inspection device according to Technical proposal 1 or 2, further comprising:
a first fixing member,
the first fixing member fixing the second partial region to at least one of the first member or the second member.

### Technical Proposal 7

The acoustic wave inspection device according to Technical proposal 1 or 2, further comprising:
a second fixing member,
the second fixing member being configured to fix a distance between the first member and the second member.

### Technical Proposal 8

The acoustic wave inspection device according to Technical proposal 7, wherein
the second fixing member includes a screw.

### Technical Proposal 9

The acoustic wave inspection device according to any one of Technical proposals 1 to 8, wherein
a Young's modulus of the sheet member is higher than a Young's modulus of the elastic member.

### Technical Proposal 10

The acoustic wave inspection device according to any one of Technical proposals 1 to 8, wherein
a Young's modulus of the sheet member is not less than 100 MPa and not more than 700 GPa.

### Technical Proposal 11

The acoustic wave inspection device according to any one of Technical proposals 1 to 8, wherein
a Young's modulus of the elastic member is not less than 0.1 MPa and not more than 100 MPa, and
a thickness of the elastic member along the first direction of the elastic member is not less than 0.5 mm and not more than 2 mm.

### Technical Proposal 12

The acoustic wave inspection device according to any one of Technical proposals 1 to 11, wherein
a width of the plurality of openings along the first plane is not less than 10 μm and not more than 1200 μm.

### Technical Proposal 13

The acoustic wave inspection device according to any one of Technical proposals 1 to 12, wherein
the sheet member includes one of the plurality of openings and another one of the plurality of openings,
the other one of the plurality of openings is next to the one of the plurality of openings, and
a distance between the other one of the plurality of openings and the one of the plurality of openings is not more than 10 μm and not more than 500 μm.

### Technical Proposal 14

The acoustic wave inspection device according to any one of Technical proposals 1 to 13, wherein
a tension in the first partial region is 1 N/cm or more.

### Technical Proposal 15

The acoustic wave inspection device according to Technical proposal 1 or 2, wherein
the first member includes a first facing portion that faces the second member, and
the first facing portion is tubular.

### Technical Proposal 16

The acoustic wave inspection device according to Technical proposal 15, wherein
the first facing portion is cylindrical or polygonal tubular.

### Technical Proposal 17

The acoustic wave inspection device according to Technical proposal 2, wherein
a frequency of the acoustic waves is not less than 0.5 MHz and not more than 15 MHz.

### Technical Proposal 18

The acoustic wave inspection device according to any one of Technical proposals 1 to 17, wherein
the sheet member is configured to come into contact with a target object, and
a distance between the target object and the transducer along the first direction is configured to be reversibly changed.

### Technical Proposal 19

The acoustic wave inspection device according to any one of Technical proposals 1 to 18, wherein
the sheet member includes at least one selected from the group consisting of polyester, polyethylene, polypropylene, polytetrafluoroethylene, polychlorotrifluoroethylene, polyvinylidene fluoride, polyvinyl fluoride, polyphenylene sulfide, and polyvinylidene chloride.

### Technical Proposal 20

The acoustic wave inspection device according to any one of Technical proposals 1 to 19, wherein
the elastic member includes at least one selected from the group consisting of polystyrene-based thermoplastic elastomer, polyolefin-based thermoplastic elastomer, vinyl chloride-based thermoplastic elastomer, polyurethane-based thermoplastic elastomer, polyester-based thermoplastic elastomer, polyamide-based thermoplastic elastomer, styrene-butadiene rubber, isoprene rubber, butadiene rubber, chloroprene rubber, acrylonitrile-butadiene rubber, isobutylene-isoprene rubber, ethylene-propylene rubber, ethylene-propylene-diene rubber, urethane rubber, silicone rubber, fluororubber, chlorosulfonated polyethylene, chlorinated polyethylene, acrylic rubber, polysulfide rubber, and epichlorohydrin rubber.

### Technical Proposal 21

The acoustic wave inspection device according to any one of Technical proposals 1 to 20, wherein
the transducer is fixed to the second member by a fixing portion.

### Technical Proposal 22

An acoustic wave inspection method using the acoustic wave inspection device according to any one of Technical proposals 1 to 21.

According to the embodiment, an acoustic wave inspection device capable of improving characteristics is provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in acoustic wave inspection devices such as transducers, members, sheet members, elastic members, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all acoustic wave inspection devices practicable by an appropriate design modification by one skilled in the art based on the acoustic wave inspection devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An acoustic wave inspection device comprising:
a transducer;
a first member being around the transducer in a first plane;
a second member being between the transducer and the first member in the first plane;
a sheet member including a plurality of openings, the sheet member including a first partial region and a second partial region, the second partial region being between the first member and the second member in the first plane, the second partial region being fixed to at least one of the first member or the second member; and
an elastic member arranged between the first partial region and the transducer in a first direction crossing the first plane.

2. The acoustic wave inspection device according to claim 1, wherein
the transducer is configured to perform at least one of emitting acoustic waves or detecting acoustic waves.

3. The acoustic wave inspection device according to claim 1, wherein
the first member includes a first facing portion,
the second member includes a second facing portion,
a direction from the first facing portion to the second facing portion is along the first plane,
the second partial region is between the first facing portion and the second facing portion, and
at least one of the first facing portion or the second facing portion includes a recess.

4. The acoustic wave inspection device according to claim 1, further comprising:
a first fixing member,
the first fixing member being located at a position of at least of a first position between the first member and the second partial region, and a second position between the second member and the second partial region.

5. The acoustic wave inspection device according to claim 4, wherein
a first Young's modulus of the first fixing member is lower than a second Young's modulus of the second partial region.

6. The acoustic wave inspection device according to claim 1, further comprising:
a first fixing member,
the first fixing member fixing the second partial region to at least one of the first member or the second member.

7. The acoustic wave inspection device according to claim 1, further comprising:
a second fixing member,
the second fixing member being configured to fix a distance between the first member and the second member.

8. The acoustic wave inspection device according to claim 7, wherein
the second fixing member includes a screw.

9. The acoustic wave inspection device according to claim 1, wherein
a Young's modulus of the sheet member is higher than a Young's modulus of the elastic member.

10. The acoustic wave inspection device according to claim 1, wherein
a Young's modulus of the sheet member is not less than 100 MPa and not more than 700 GPa.

11. The acoustic wave inspection device according to claim 1, wherein
a Young's modulus of the elastic member is not less than 0.1 MPa and not more than 100 MPa, and
a thickness of the elastic member along the first direction of the elastic member is not less than 0.5 mm and not more than 2 mm.

12. The acoustic wave inspection device according to claim 1, wherein
a width of the plurality of openings along the first plane is not less than 10 μm and not more than 1200 μm.

13. The acoustic wave inspection device according to claim 1, wherein
the sheet member includes one of the plurality of openings and another one of the plurality of openings,
the other one of the plurality of openings is next to the one of the plurality of openings, and
a distance between the other one of the plurality of openings and the one of the plurality of openings is not more than 10 μm and not more than 500 μm.

14. The acoustic wave inspection device according to claim 1, wherein
a tension in the first partial region is 1 N/cm or more.

15. The acoustic wave inspection device according to claim 1, wherein
the first member includes a first facing portion that faces the second member, and
the first facing portion is tubular.

16. The acoustic wave inspection device according to claim 15, wherein
the first facing portion is cylindrical or polygonal tubular.

17. The acoustic wave inspection device according to claim 2, wherein
a frequency of the acoustic waves is not less than 0.5 MHz and not more than 15 MHz.

18. The acoustic wave inspection device according to claim 1, wherein
the sheet member is configured to come into contact with a target object, and
a distance between the target object and the transducer along the first direction is configured to be reversibly changed.

19. The acoustic wave inspection device according to claim 1, wherein
the sheet member includes at least one selected from the group consisting of polyester, polyethylene, polypropylene, polytetrafluoroethylene, polychlorotrifluoroethylene, polyvinylidene fluoride, polyvinyl fluoride, polyphenylene sulfide, and polyvinylidene chloride.

20. The acoustic wave inspection device according to claim 1, wherein
the elastic member includes at least one selected from the group consisting of polystyrene-based thermoplastic elastomer, polyolefin-based thermoplastic elastomer, vinyl chloride-based thermoplastic elastomer, polyurethane-based thermoplastic elastomer, polyester-based thermoplastic elastomer, polyamide-based thermoplastic elastomer, styrene-butadiene rubber, isoprene rubber, butadiene rubber, chloroprene rubber, acrylonitrile-butadiene rubber, isobutylene-isoprene rubber, ethylene-propylene rubber, ethylene-propylene-diene rubber, urethane rubber, silicone rubber, fluororubber, chlorosulfonated polyethylene, chlorinated polyethylene, acrylic rubber, polysulfide rubber, and epichlorohydrin rubber.
